(19) United States
(12) Patent Application Publication
(10) Pub. No.: US 2023/0340915 A1
(43) Pub. Date: Oct. 26, 2023

(54) PROPULSION SYSTEM

(71) Applicant: Derwent Technologies Ltd., Burton on Trent (GB)

(72) Inventors: Trevor Harold SPEAK, Dursley (GB); Robert John SELLICK, East Grinstead (GB)

(21) Appl. No.: 18/189,483

(22) Filed: Mar. 24, 2023

(30) Foreign Application Priority Data
Apr. 20, 2022 (GB) 2205731.9

(51) Int. Cl. F02C 9/40; B64D 27/10; B64D 37/30

(52) U.S. Cl. CPC F02C 9/40; B64D 27/10; B64D 37/30

(57) ABSTRACT

A propulsion system for aircraft comprises fuel reservoirs for storing hydrogen and a fuel reservoir for storing a liquid hydrocarbon fuel (HC). A gas turbine engine may comprise a fuel injection unit comprising: a hydrogen pilot burner in communication with hydrogen fuel reservoirs via flow control valves. A dual fuel main burner in communication with the hydrogen fuel reservoirs via a flow control valve and in communication with the HC reservoir via a third flow control valve may also be provided. A control system may be operable to control: the flow control valves to control flow of hydrogen from the hydrogen fuel reservoirs to the hydrogen pilot burner; the flow control valve to control flow of hydrogen from the hydrogen fuel reservoirs to the dual fuel main burner; and the flow control valve to control flow of the HC from the HC reservoir to the dual fuel main burner.

### CROSS-REFERENCE TO RELATED APPLICATIONS

This application is related to and claims priority to United Kingdom App. No. GB 2205731.9, filed Apr. 20, 2022, entitled PROPULSION SYSTEM, the entirety of which is incorporated herein by reference.

### GOVERNMENT RIGHTS STATEMENT

N/A.

### FIELD

The present disclosure generally relates to a propulsion system. In particular, the disclosure is concerned with a fuel and propulsion system for an aircraft.

### BACKGROUND

Dual fuel capability (i.e. using more than one fuel type at a time, for example as a blend of hydrogen and methane) has been employed on industrial gas turbines. This results in reduced emissions of carbon dioxide which is a driver of climate change. Since hydrogen and methane are both gasses at ambient conditions, dual fuel capability can be achieved by premixing the fuels.

Hydrogen has been proposed as a fuel for aircraft gas turbines in order to similarly reduce carbon emissions into the atmosphere. However, hydrogen, even in liquid form, occupies a much higher volume per unit energy generation than the liquid hydrocarbon fuels such as kerosene which are currently in use. This greater fuel volume gives rise to significantly increased aircraft size and hence drag and/or reduced payload volume and passenger numbers. The capability of an aircraft to use a combination of hydrogen and liquid hydrocarbon fuel would reduce the volume of hydrogen required by the aircraft and hence also the reduce the drag penalty.

Hence a propulsion system for an aircraft capable of running on a combination of hydrogen and liquid hydrocarbon fuel, with a configuration which enables a switch to burn hydrogen and a liquid hydrocarbon separately or at the same time when needed to deliver power output at acceptable combustion temperatures, stability margins and exhaust emissions is highly desirable.

### SUMMARY

According to the present disclosure there is provided an apparatus and method as set forth in the appended claims. Other features of the invention will be apparent from the dependent claims, and the description which follows.

Accordingly, there may be provided a propulsion system (300) for an aircraft (10) comprising: a first fuel reservoir (100) configured for storing hydrogen (H2-1); a second fuel reservoir (200) configured for storing a hydrocarbon fuel (HC) and a gas turbine engine (400) comprising a fuel injection unit (500). The fuel injection unit (500) may comprise: a hydrogen pilot burner (510) in fluid communication with the first fuel reservoir (100) via a first flow control valve (512); a dual fuel main burner (520) in fluid communication with the first fuel reservoir (100) via a second flow control valve (522) and in fluid communication with the second fuel reservoir (200) via a third flow control valve (532). The propulsion system (300) may further comprise a control system (600) operable to control: the first flow control valve (512) to control the flow of hydrogen (H2-1) from the first fuel reservoir (100) to the hydrogen pilot burner (510); the second flow control valve (522) to control the flow of hydrogen from the first fuel reservoir (100) to the dual fuel main burner (520), and/or the third flow control valve (532) to control the flow of the hydrocarbon fuel (HC) from the second fuel reservoir (200) to the dual fuel main burner (520).

The first fuel reservoir (100) may be a low temperature and low-pressure reservoir for storing liquid hydrogen. The propulsion system may further comprise a third fuel reservoir (800) configured for storing pressurized hydrogen gas (H2-2). The third fuel reservoir (800) may be in fluid communication with the hydrogen pilot burner (510) via a fourth flow control valve (542). The control system (600) may be operable to control the fourth flow control valve (542) to control the flow of hydrogen (H2-2) from the third fuel reservoir (800) to the hydrogen pilot burner (510), the third fuel reservoir (800) being in fluid communication with the hydrogen pilot burner (510) via a fourth flow control valve (542).

The first fuel reservoir (100) may be in fluid communication with the hydrogen pilot burner (510) via a heat exchanger (110) configured to deliver heat to the liquid hydrogen delivered from the first fuel reservoir (100) to convert it into gaseous form.

The hydrogen pilot burner (510) may comprise a plurality of flow outlets (514) in flow communication with the first fuel reservoir (100).

The hydrogen pilot burner (510) may comprise a plurality of flow outlets (514) in flow communication with the first fuel reservoir (100) and the third fuel reservoir (800).

The dual fuel main burner (520) may comprise a plurality of outlets (524, 528) which surround the hydrogen pilot burner (510). A first subset (528) of dual fuel main burner outlets (524) may be in flow communication with the first fuel reservoir (100) via a first flow passage (550); and a second subset (530) of the dual fuel main burner outlets (524) are in flow communication with the second fuel reservoir (200) via a second flow passage (552); the first flow passage (550) and second flow passage (552) being fluidly isolated from one another.

The control system (600) may be operable to control the first flow control valve (512), second flow control valve (522) and third flow control valve (532) such that:
a. in a first mode of operation, the first flow control valve (512) is open, the second flow control valve (522) is closed and the third flow control valve (532) is closed such that only hydrogen is delivered to the pilot burner (510);
b. in a second mode of operation, the first flow control valve (512) is open, the second flow control valve (522) is open and the third flow control valve (532) is closed such that only hydrogen is delivered to the pilot burner (510) and dual fuel main burner (520);
c. in a third mode of operation, the first flow control valve (512) is open to deliver hydrogen to the pilot burner (510) and both the second flow control valve (522) and third flow control valve (532) are open such that hydrogen and hydrocarbon fuel (HC) are delivered to the dual fuel main burner (520); and
d. in a fourth mode of operation, the first flow control valve (512) is open such that only hydrogen is delivered to the pilot burner (510); the second flow control valve (522) is closed and the third flow control valve (532) is open such that only hydrocarbon fuel (HC) is delivered to the dual fuel main burner (520).

The control system (600) may be operable to control the fourth flow control valve (542) to be closed in the first, second, third, and fourth mode of operation.

The control system (600) may be operable to control the first flow control valve (512), second flow control valve (522), third flow control valve (532) and fourth flow control valve (542) such that:
in a fifth mode of operation, the first flow control valve (512) is closed, the second flow control valve (522) is closed and the third flow control valve (532) is closed and the fourth flow control valve (542) is open such that only hydrogen is delivered to the pilot burner (510) from the third fuel reservoir (800); and
in a sixth mode of operation the first flow control valve (512) is closed, the second flow control valve (522) is closed; the third flow control valve (532) is open such that only hydrocarbon fuel (HC) is delivered to the dual fuel main burner (520); and the fourth flow control valve (542) is open to deliver hydrogen to the pilot burner (510) from the third fuel reservoir (800).

The control system (600) is operable to control the first flow control valve (512), second flow control valve (522), third flow control valve (532) and fourth flow control valve (542) such that: in a seventh mode of operation the first flow control valve (512) and fourth flow control valve (542) are closed such that no fuel is delivered to the pilot burner (510), and the second control valve (522) is closed and third flow control valve (532) is open such that only hydrocarbon fuel (HC) is delivered to the dual fuel main burner (520).

The gas turbine engine (400) may further comprise a combustor (700).

There may also be provided an aircraft (10) comprising a propulsion system (300) according to the present disclosure wherein: the control system (600) is operable to control the rate of opening/closing of the first flow control valve (512), second flow control valve (522) and third flow control valve (532) relative to one another to transition between the first mode of operation, second mode of operation, third mode of operation and/or fourth mode of operation.

The control system (600) may be operable to control the rate of opening/closing of the first flow control valve (512), second flow control valve (522), third flow control and fourth control valve (542) relative to one another to transition between the modes of operation.

The first mode of operation may correspond to a gas turbine engine (400) start, idle and/or low-power condition. The other modes of operation provide a range of power conditions.

Hence there is provided a propulsion system for an aircraft capable of running on hydrogen, with the ability to switch to a hydrocarbon fuel, or burn hydrogen and a hydrocarbon at the same time when needed for a particular engine condition (for example take off).

### BRIEF DESCRIPTION OF THE DRAWINGS

Examples of the present disclosure will now be described with reference to the accompanying drawings, in which:

FIG. 1 shows a representation of a view of an aircraft comprising a fuel and propulsion system according to the present disclosure;

FIG. 2 is a diagrammatic representation of the fuel and propulsion system according to the present disclosure;

FIGS. 3 to 7 illustrate different possible modes of operation of the propulsion system shown in FIG. 2;

FIG. 8 shows a cross-sectional view of part of an example of a fuel injector and combustor which may be used in the propulsion system according to the present disclosure; and

FIG. 9 shows an end on view of the fuel injector shown in FIG. 8.

### DETAILED DESCRIPTION

The present disclosure relates to a propulsion system for an aircraft, an aircraft comprising a propulsion system according to the present disclosure, and a method of operation of the propulsion system and a method of operation of the aircraft.

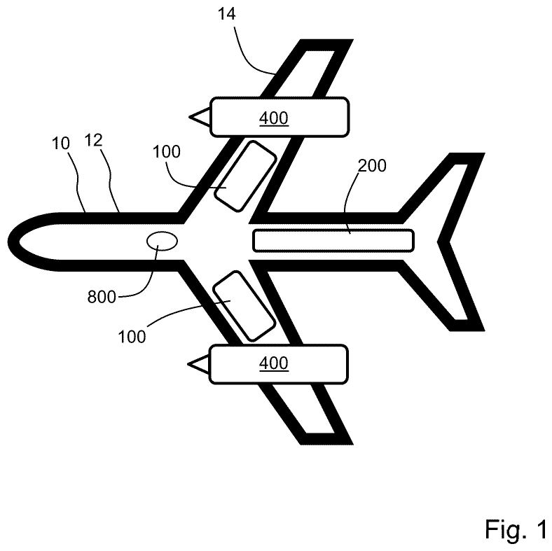

A diagrammatic representation of an aircraft 10 comprising a propulsion system 300 according to the present disclosure is shown in FIG. 1. Hence the aircraft 10 may comprise a fuselage 12 and wings 14. The propulsion system 300 may comprise a first fuel reservoir 100 configured for storing hydrogen (H2-1) and a second fuel reservoir 200 configured for storing a hydrocarbon fuel (HC). The first fuel reservoir (which may also be termed a “first hydrogen fuel reservoir”) 100 may be a low temperature and low-pressure reservoir for storing liquid hydrogen. The first fuel reservoir 100 may be in fluid communication with the hydrogen pilot burner 510 via a heat exchanger 110 configured to deliver heat to the liquid hydrogen delivered from the first fuel reservoir 100 to convert it into gaseous form.

The propulsion system may further comprise a third fuel reservoir 800 configured for storing pressurized hydrogen gas H2-2. The third fuel reservoir 800 (which may also be termed a “second hydrogen fuel reservoir”) may be in fluid communication with the hydrogen pilot burner 510 via a fourth flow control valve 542.

The location of the reservoirs 100, 200, 800 shown in FIG. 1 is by way of example only. The location of engines and fuel tanks shown in FIG. 1 are typical, but may be provided in different locations and configurations to that shown.

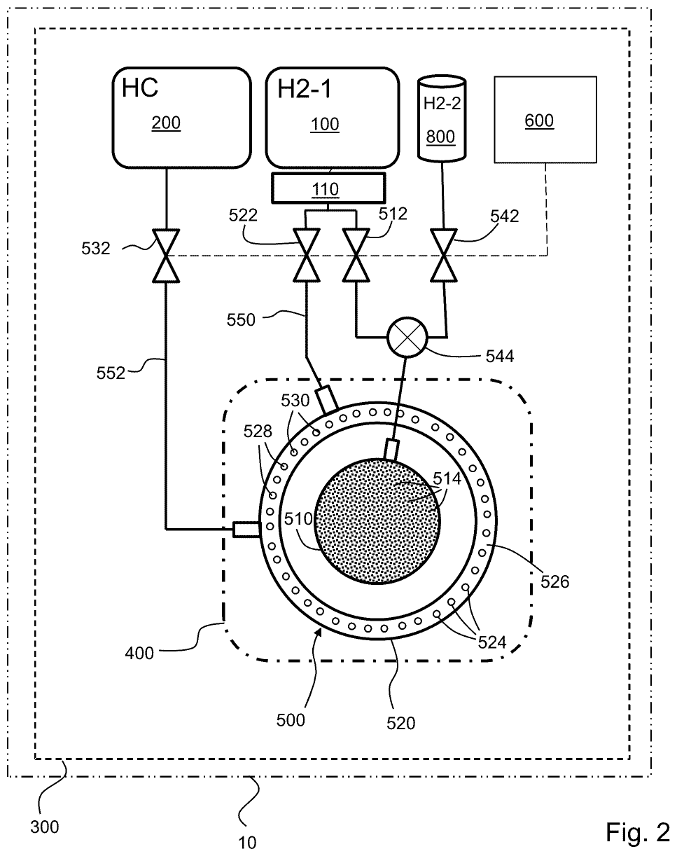

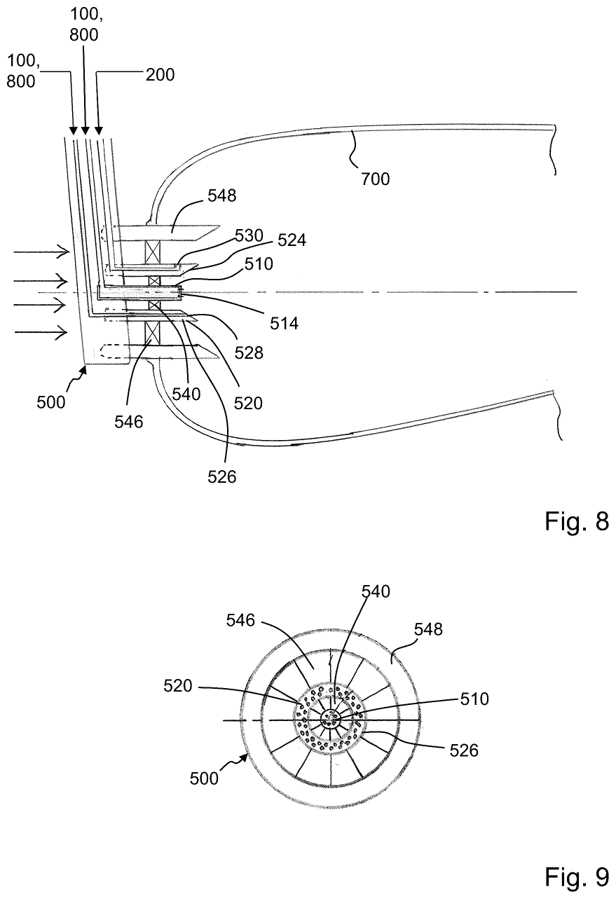

The propulsion system may further comprise a gas turbine engine 400 comprising a fuel injection unit 500, for example as shown in FIGS. 2 to 7 and FIGS. 8 and 9. The gas turbine engine 400 further comprises a combustor 700 into which the fuel injection unit 500 delivers fuel. In FIGS. 2 to 7 the combustor is not shown. An example of a combustor 700 is shown in FIG. 8. The combustor 700 may be annular, as shown in FIG. 8. Other examples the combustor may have different configurations. The design of the combustor 700 may be of any suitable design, and its detail need not be discussed here. Likewise there may be provided more than one fuel injection unit 500, for example in an annular combustor 700, there may be provided a plurality of fuel injection units 500 spaced around an inlet to the combustor 700. Alternatively, if the engine 400 comprises a plurality of combustors, then each combustor may be provided with one or more fuel injection units 500.

The heat exchanger 110 may be in thermal communication with a heat source. In some examples the heat source may be the engine 400. Hence some of the heat generated by the engine 400 may be transferred to the liquid hydrogen as it travels between the first reservoir 102 the fuel injection unit 500.

The fuel injection unit 500 may comprise a hydrogen pilot burner 510 in fluid communication with the first hydrogen fuel reservoir 100 via a first flow control valve 512. In examples in which the second hydrogen fuel reservoir 800 is provided, the hydrogen pilot burner 510 may be in fluid communication with the second hydrogen fuel reservoir 800 via a second flow control valve 542. For example the hydrogen pilot burner 510 may be in fluid communication with only a source of hydrogen fuel, and is fully isolated from a source of any other fuel.

The fuel injection unit 500 may further comprise a dual fuel main burner 520 in fluid communication with the first fuel reservoir 100 via a second flow control valve 522 and in fluid communication with the second fuel reservoir 200 via a third flow control valve 532.

The propulsion system 300 may further comprise a control system 600 operable to control the first flow control valve 512 to control the flow of hydrogen H2-1 from the first fuel reservoir 100 to the hydrogen pilot burner 510, the second flow control valve 522 to control the flow of hydrogen from the first fuel reservoir 100 to the dual fuel main burner 520 and the third flow control valve 532 to control the flow of the hydrocarbon fuel HC from the second fuel reservoir 200 to the dual fuel main burner 520.

The control system 600 may be operable to control the fourth flow control valve 542 to control the flow of hydrogen H2-2 from the third fuel reservoir 800 to the hydrogen pilot burner 510.

As shown in FIGS. 2 to 7 and 9 the hydrogen pilot burner 510 comprises a plurality of flow outlets 514 in flow communication with the first fuel reservoir 100 via a flow passage 562a. That is to say the hydrogen pilot burner 510 comprises a first inlet 560 to a third manifold which is in fluid communication with plurality of flow outlets 514 via a flow passage 562a. The plurality of flow outlets 514 may additionally be in flow communication with the third fuel reservoir 800 via a flow passage 562b.

The flow passage 562a and flow passage 562b may be in flow communication with the first inlet 560 via a valve 544. A further flow passage 564 may provide fluid communication between the valve 544 and the inlet 560.

As shown in FIG. 8, the plurality of flow outlets 514 may be provided on a downstream end face of the hydrogen pilot burner 510.

An inner swirler 540 may extend radially outwards from the hydrogen pilot burner 510 to the dual fuel burner 520 to thereby physically link the hydrogen pilot burner 510 and the dual fuel burner 520, for example so that one may be carried on the other.

An outer swirler 546 may extend radially outwards from the dual fuel burner 520 to a shroud 548 to thereby physically link the dual fuel burner 520 and the shroud 546, for example so that one may be carried on the other.

The inner swirler 540 and the outer swirler 546 may comprise a plurality of spaced apart vanes to allow the passage of air therebetween. The vanes may be angled to the direction of flow to thereby impart swirl to the airflow to therefore aid with the mixing of the fuel and air delivered to the combustor 700. The vanes may also be angled in such a way to impart swirl to the airflow to atomize the liquid hydrocarbon fuel to aid with its combustion and mixing with hydrogen.

The dual fuel main burner 520 may be provided as a ring 526 around the hydrogen pilot burner 510. A plurality of outlets 524 may be provided on the downstream end of the ring 526, such that the outlets 524 surround the hydrogen pilot burner 510.

A first subset 528 of dual fuel main burner outlets 524 are in flow communication with the first fuel reservoir 100 via a first flow passage 550. That is to say the ring 526 comprises a second inlet 556 to a second manifold which is in fluid communication with the first subset 528 of the dual main burner outlets 524. A second subset 530 of the dual fuel main burner outlets 524 are in flow communication with the second fuel reservoir 200 via a second flow passage 552. That is to say the ring 526 comprises a third inlet 559 to a second manifold which is in fluid communication with the second subset 530 of the dual main burner outlets 524. The first flow passage 550 and second flow passage 552 are fluidly isolated from one another. The first manifold and second manifold are fluidly isolated from one another.

In one example (as shown in FIG. 2), the first subset 528 and second subset 530 of the dual fuel main burner outlets 524 may be provided on the downstream end/face of the ring 526.

In a second example (as shown in FIG. 8) the first subset 528 and second subset 530 of the dual fuel main burner outlets 524 may be provided on the downstream end/face of the ring 526 and the second subset 530 of the dual main burner outlets 524 may extend radially for example as shown in FIG. 8, exiting the body of the dual fuel main burner upstream of the face on which the first subset 528 of dual fuel main burner outlets 524 are located.

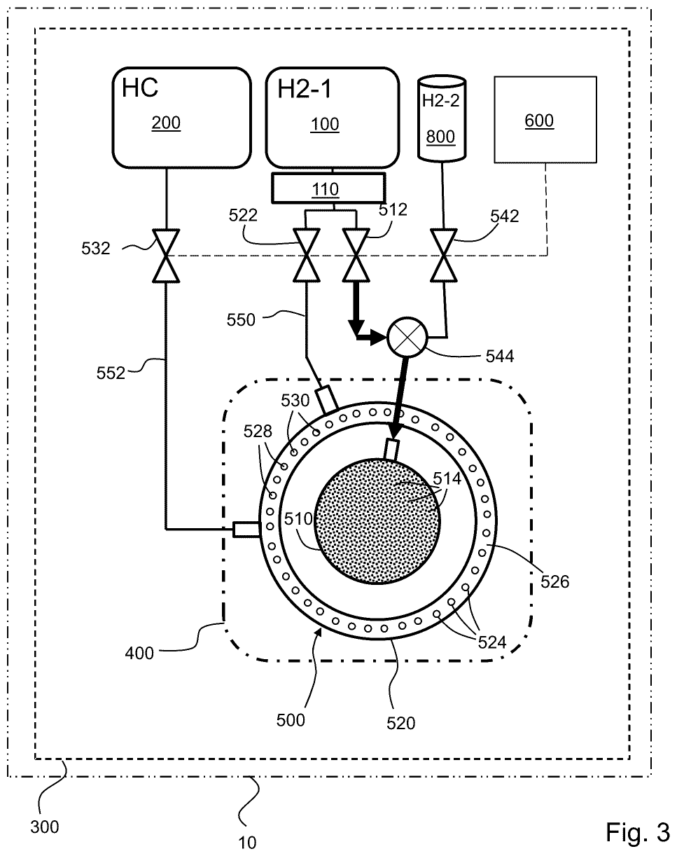

The control system 600 may be operable to control the first flow control valve 512, second flow control valve 522 and third flow control valve 532 in different modes of operation, as shown in FIGS. 3 to 7. In FIGS. 3 to 7, arrows overlaid on flow passages indicate flow along the flow passage. Where there is no arrow indicating flow, there is no flow.

In a first mode of operation, as shown in FIG. 3, the first flow control valve 512 is open, the second flow control valve 522 is closed and the third flow control valve 532 is closed such that only hydrogen is delivered to the pilot burner 510. The first mode of operation may correspond to a gas turbine engine 400 start, idle and/or low-power condition.

The other modes of operation, set out below, provide a range of power conditions to best match the requirements of the propulsion system 300 and aircraft 10 mission.

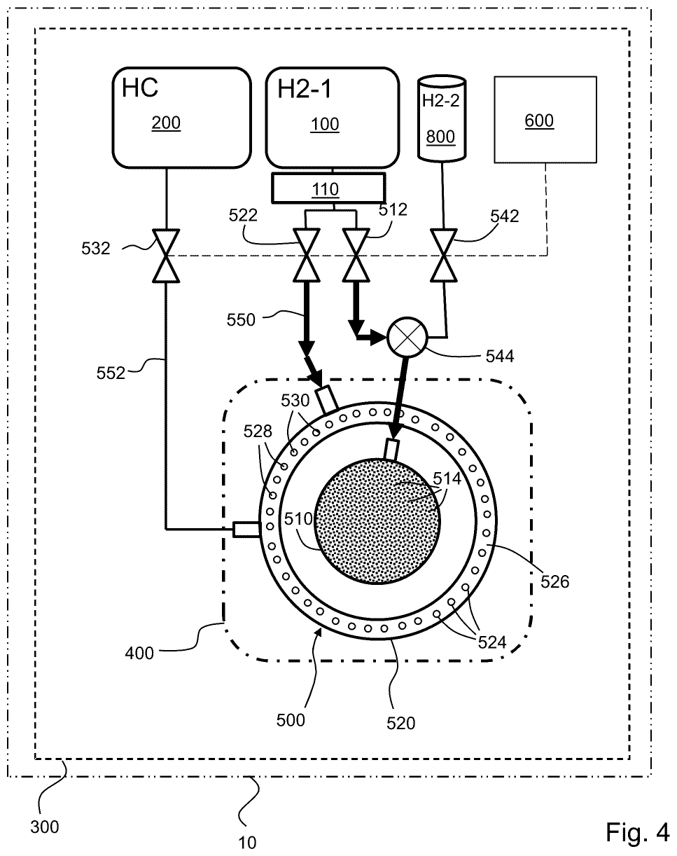

In a second mode of operation, as shown in FIG. 4, the first flow control valve 512 is open, the second flow control valve 522 is open and the third flow control valve 532 is closed such that only hydrogen is delivered to the pilot burner 510 and dual fuel main burner 520. This may provide a high power cruise condition.

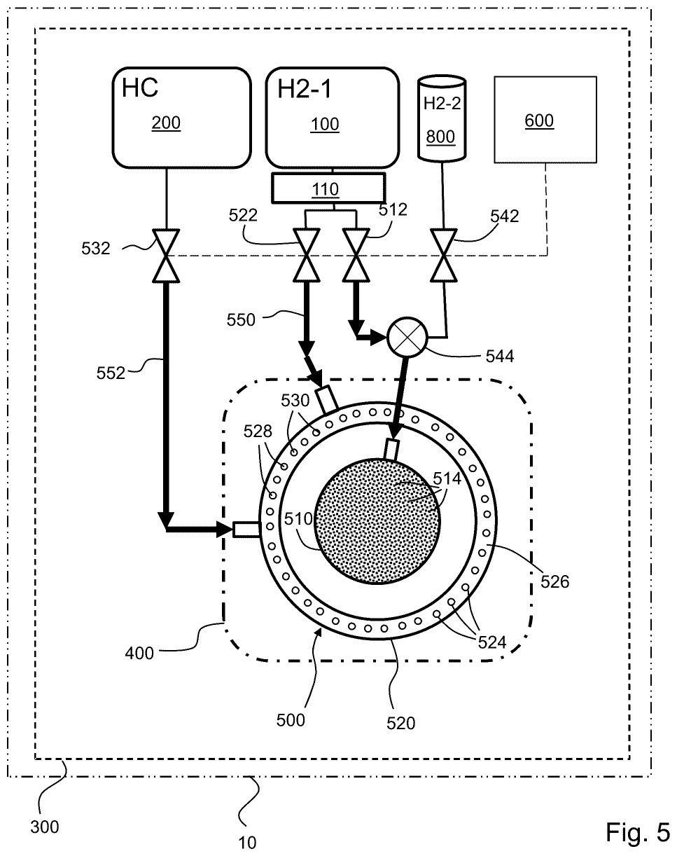

In a third mode of operation, as shown in FIG. 5, the first flow control valve 512 is open to deliver hydrogen to the pilot burner 510 and both the second flow control valve 522 and third flow control valve 532 are open such that hydrogen and hydrocarbon fuel HC are delivered to the dual fuel main burner 520. This may correspond to a high power condition to maximize CO2 reduction subject to satisfactory NOx emissions.

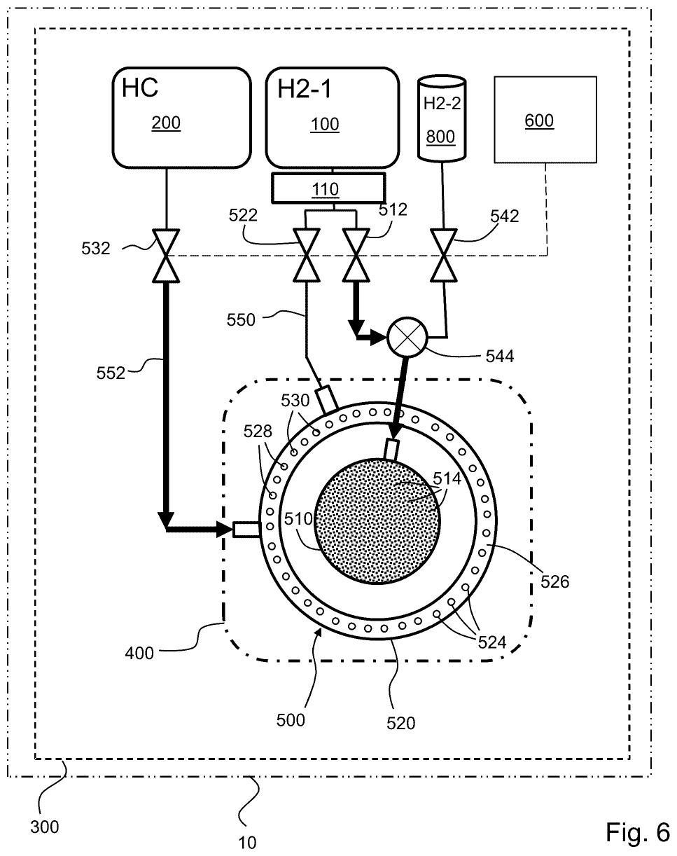

In a fourth mode of operation, as shown in FIG. 6, the first flow control valve 512 is open such that only hydrogen is delivered to the pilot burner 510, and the second flow control valve 522 is closed and the third flow control valve 532 is open such that only hydrocarbon fuel HC is delivered to the dual fuel main burner 520. This mode may correspond to an aircraft/engine take-off condition.

In examples where the fourth flow control valve 542 is present, the control system 600 is operable to control the fourth flow control valve 542 to be closed in the first, second, third and fourth mode of operation.

Hence in the first, second, third, and fourth mode of operation a constant pilot burner flame is provided. In examples where hydrocarbon fuel is provided, this enables leaner burning of the hydrocarbon fuel in the main burner 520, resulting in a cleaner burn and avoids a rich burning primary zone required by conventional twin annular staged burners which limits NOx reduction capability.

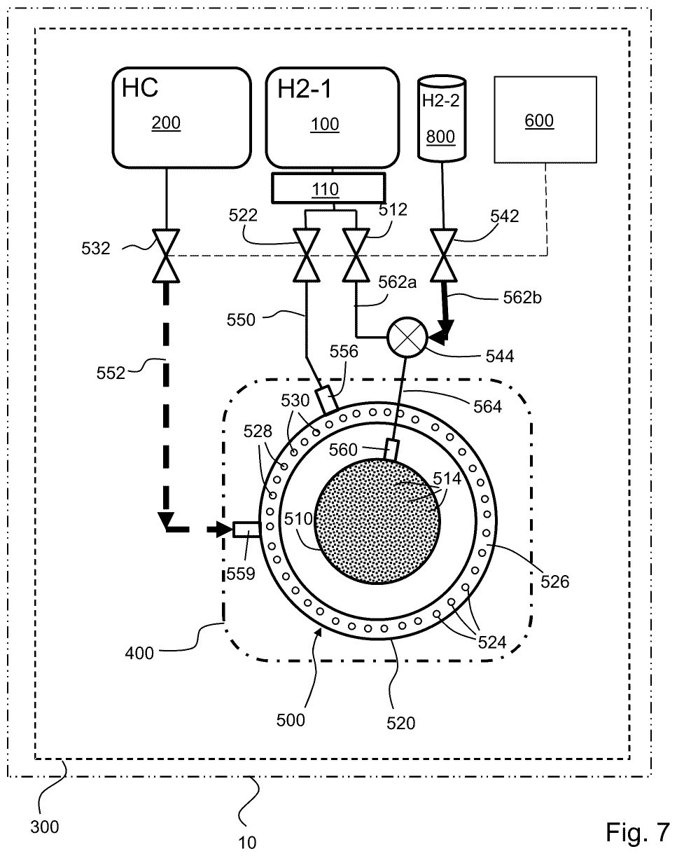

The control system 600 is operable to control the first flow control valve 512, second flow control valve 522, third flow control valve 532 and fourth flow control valve 542 such that in a fifth mode of operation, as shown in FIG. 7, the first flow control valve 512 is closed, the second flow control valve 522 is closed and the third flow control valve 532 is closed and the fourth flow control valve 542 is open such that only hydrogen is delivered to the pilot burner 510 from the third fuel reservoir 800. The fifth mode of operation may correspond to a normal engine start mode and can be used to provide hydrogen to the pilot burner when supplies of liquid hydrogen from the first hydrogen fuel reservoir 100 are not available.

The control system 600 is operable to control the first flow control valve 512, second flow control valve 522, third flow control valve 532 and fourth flow control valve 542 such that in a sixth mode of operation, as shown in FIG. 7, the first flow control valve 512 is closed, the second flow control valve 522 is closed and the third flow control valve 532 is open such that only hydrocarbon fuel HC is delivered to the dual fuel main burner 520 (as indicated by a bold dashed line overlaying flow passage 552) and the fourth flow control valve 542 is open to deliver hydrogen to the pilot burner 510 from the third fuel reservoir 800.

The control system 600 is operable to control the first flow control valve 512, second flow control valve 522, third flow control valve 532 and fourth flow control valve 542 such that in a seventh mode of operation the first flow control valve 512, and fourth flow control valve 542 are closed such that no fuel is delivered to the pilot burner 510, and the second control valve (522) is closed and third flow control valve 532 is open such that only hydrocarbon fuel HC is delivered to the dual fuel main burner 520. Such an example may be at higher power output conditions of the gas turbine engine when a main flame is stable and the pilot burner is not required. This mode may also mitigate the risk of thermal distress of the pilot burner caused by hydrogen combustion at the very severe Take-Off operating conditions. This mode may also permit aircraft operation when a source of liquid hydrogen fuel is not available. For example, this mode of operation may permit operation/recovery from airports without hydrogen refuelling stations to airports with such a capability. This mode may also correspond to an engine cruise state, with the pilot burner switched off, as the pilot burner may only be required for low power operation.

The control system 600 is operable to control the rate of opening/closing of the first flow control valve 512, second flow control valve 522 and third flow control valve 532 relative to one another to transition between the first mode of operation, second mode of operation, third mode of operation and/or fourth mode of operation.

The control system 600 is operable to control the rate of opening/closing of the first flow control valve 512, second flow control valve 522, third flow control and fourth control valve 542 relative to one another to transition between the modes of operation.

The fuel injection unit 500 comprising a hydrogen pilot injector 510 has been developed to address the problems created for aircraft 10 and gas turbine engine 400 by the significantly different physical properties of hydrogen compared to conventional hydrocarbon fuels HC.

For the aircraft 10 the major issue of using hydrogen as a fuel is the low volumetric density of hydrogen which results in the need for large tanks with the attendant weight and aerodynamic drag penalties. Passenger carrying capacity can also be reduced.

By using liquid hydrogen stored at cryogenic temperatures (−253K), the volume required to store the hydrogen fuel in an aircraft is reduced, thus resulting in less impact on aircraft range.

The hydrogen tank size required for supplying the pilot jet will be significantly smaller than an 100% hydrogen fuelled aircraft 10 and there are more options where it can be located on the aircraft 10. In addition to this baseline piloted burner which permits full aircraft 10 range capability, provision of an additional hydrogen feed to the main burner would permit an increase in CO2 saved without increasing tank size. This flow would be modulated according to the length of flight.

Additionally, carrying a supply of hydrocarbon fuel such as kerosene or sustainable aviation fuel allows the aircraft 10 to operate over longer flights on both fuels over the full thrust range.

Liquid hydrocarbon can be used for the reserve fuel that has to be carried in case of diversion. This reduces the size of the hydrogen tanks and associated weight and drag penalties.

The ability to vary the ratio of liquid hydrocarbon and hydrogen consumed during cruise is another potential mitigation to manage the increased contrail risk caused by hydrogen combustion.

The extreme reactivity of hydrogen and high extinction strain rate results in excellent flame stability and permits use of lower equivalence ratios to reduce flame temperature without flame weak extinction problems when operating at low power or under-fuelling conditions when decelerating the gas turbine engine 400.

The use of a hydrogen fuelled pilot zone that can be operated at very low equivalence ratios has the potential to remove the constraint limiting the NOx reduction that can be achieved by current burner concepts.

This arrangement of the present disclosure would also permit the supply of additional hydrogen to the main burner to be restricted to flight conditions such as cruise where the compressor delivery pressures and temperatures are significantly lower and the risk of damaging the fuel injector is reduced. Injecting the hydrogen to the main burner airflow ensures combustion at a low equivalence ratio and low emissions. The lower hydrogen flow also reduces the size of the fuel delivery and heat management system.

Low power operation around the airport can be hydrogen fuelled which will reduce unburnt hydrocarbon and particulate emissions.

Hydrogen is predicted to be lower cost than green synthetic fuels which require hydrogen and captured CO2 to be processed. The hydrogen pilot also reduces NOx emissions from aircraft 10 using either sustainable or conventional hydrocarbon fuel HCs.

Providing a source pressurized hydrogen gas as well as liquid hydrogen gas is advantageous as pressurized hydrogen can be stored for long periods without the boil off issues of liquid hydrogen. This combination of fuel sources would permit operation/recovery from airports without hydrogen refuelling stations to airports with that capability. The aircraft range capability would depend on the pressurized tank size and pilot burner flow rate.

Additionally, a combustor configured for liquid hydrocarbon fuel (e.g. kerosene) use may be employed with the fuel injection unit 500, rather than a specially configured combustor for dual fuel use. That is to say, starting with a combustor design optimized for take-off operation, with ports and cooling configured for a Take-Off (normally Hot Day) operating point with the control system delivering kerosene to the main burner has been determined to be a suitable configuration to achieve the lowest practical primary zone temperature for the turbine entry temperature required at that flight condition. This sets the quantity of air available for liner cooling and dilution.

The inventors have determined that at the take-off condition the higher flame temperature of hydrogen dictated a leaner combustor primary zone is required to avoid excessive NOx leaving less air for cooling and dilution. A propulsion system according to the present disclosure is provided with a combustor configured to use kerosene at a take-off condition, and to exploit the excellent flame stability burning characteristics of hydrogen in the pilot zone.

In the propulsion system of the present disclosure, in order to increase the quantity of hydrogen that is consumed in a flight, additional hydrogen is delivered to the main burner during cruise.

The control system arrangement of the present disclosure permits the ratio of hydrogen to hydrocarbon to be varied to therefore enable the performance of the propulsion system to be “tuned” as required.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A propulsion system for an aircraft comprising:
a first fuel reservoir configured for storing hydrogen (H2-1);
a second fuel reservoir configured for storing a hydrocarbon fuel (HC);
a gas turbine engine comprising a fuel injection unit comprising:
a hydrogen pilot burner in fluid communication with the first fuel reservoir via a first flow control valve;
a dual fuel main burner in fluid communication with the first fuel reservoir via a second flow control valve and in fluid communication with the second fuel reservoir via a third flow control valve;
a control system operable to control:
the first flow control valve to control the flow of hydrogen (H2-1) from the first fuel reservoir to the hydrogen pilot burner;
the second flow control valve to control the flow of hydrogen from the first fuel reservoir to the dual fuel main burner;
the third flow control valve to control the flow of the hydrocarbon fuel (HC) from the second fuel reservoir to the dual fuel main burner.

2. The propulsion system of claim 1, wherein the first fuel reservoir is a low temperature and low-pressure reservoir configured for storing liquid hydrogen; and
the propulsion system further comprises a third fuel reservoir configured for storing pressurized hydrogen gas (H2-2);
the third fuel reservoir being in fluid communication with the hydrogen pilot burner via a fourth flow control valve;
the control system being operable to control:
the fourth flow control valve to control the flow of hydrogen (H2-2) from the third fuel reservoir to the hydrogen pilot burner;
the third fuel reservoir being in fluid communication with the hydrogen pilot burner via a fourth flow control valve.

3. The propulsion system of claim 2, wherein:
the first fuel reservoir is in fluid communication with the hydrogen pilot burner via a heat exchanger configured to deliver heat to the liquid hydrogen delivered from the first fuel reservoir to convert it into gaseous form.

4. The propulsion system of claim 1, wherein:
the hydrogen pilot burner comprises a plurality of flow outlets in flow communication with the first fuel reservoir.

5. The propulsion system of claim 2, wherein:
the hydrogen pilot burner comprises a plurality of flow outlets in flow communication with the first fuel reservoir and the third fuel reservoir.

6. The propulsion system of claim 1, wherein:
the dual fuel main burner comprises a plurality of outlets which surround the hydrogen pilot burner;
wherein a first subset of dual fuel main burner outlets are in flow communication with the first fuel reservoir via a first flow passage; and a second subset of the dual fuel main burner outlets are in flow communication with the second fuel reservoir via a second flow passage; the first flow passage and second flow passage being fluidly isolated from one another.

7. The propulsion system of claim 2, wherein the control system is operable to control the first flow control valve, second flow control valve, and third flow control valve (532) such that:
a. in a first mode of operation, the first flow control valve is open, the second flow control valve is closed, and the third flow control valve is closed such that only hydrogen is delivered to the pilot burner;
b. in a second mode of operation, the first flow control valve is open, the second flow control valve is open, and the third flow control valve is closed such that only hydrogen is delivered to the pilot burner and the dual fuel main burner;
c. in a third mode of operation, the first flow control valve is open to deliver hydrogen to the pilot burner, and both the second flow control valve and third flow control valve are open such that hydrogen and hydrocarbon fuel (HC) are delivered to the dual fuel main burner; and
d. in a fourth mode of operation, the first flow control valve is open such that only hydrogen is delivered to the pilot burner; the second flow control valve is closed, and the third flow control valve is open such that only hydrocarbon fuel (HC) is delivered to the dual fuel main burner.

8. The propulsion system of claim 7, wherein the control system is operable to control the fourth flow control valve to be closed in the first, second, third, and fourth mode of operation.

9. The propulsion system of claim 8, wherein the control system is operable to control the first flow control valve, the second flow control valve, the third flow control valve, and the fourth flow control valve such that:
in a fifth mode of operation, the first flow control valve is closed, the second flow control valve is closed, and the third flow control valve is closed, and the fourth flow control valve is open such that only hydrogen is delivered to the pilot burner from the third fuel reservoir; and
in a sixth mode of operation, the first flow control valve is closed, the second flow control valve is closed, and the third flow control valve is open such that only hydrocarbon fuel (HC) is delivered to the dual fuel main burner, and the fourth flow control valve is open to deliver hydrogen to the pilot burner from the third fuel reservoir.

10. The propulsion system of claim 2, wherein the control system is operable to control the first flow control valve, the second flow control valve, the third flow control valve, and the fourth flow control valve such that:
in a seventh mode of operation the first flow control valve and the fourth flow control valve are closed such that no fuel is delivered to the pilot burner, and the second control valve is closed, and the third flow control valve is open such that only hydrocarbon fuel (HC) is delivered to the dual fuel main burner.

11. The propulsion system of claim 1, wherein the gas turbine engine further comprises a combustor.

12. An aircraft comprising the propulsion system of claim 7, wherein:
the control system is operable to control the rate of opening/closing of the first flow control valve, second flow control valve, and third flow control valve relative to one another to transition between the first mode of operation, second mode of operation, third mode of operation, and/or fourth mode of operation.

13. An aircraft comprising the propulsion system of claim 9, wherein:
the control system is operable to control the rate of opening/closing of the first flow control valve, the second flow control valve, the third flow control valve, and the fourth control valve relative to one another to transition between the modes of operation.

14. An aircraft comprising the propulsion system of claim 7, wherein:
the first mode of operation corresponds to a gas turbine engine start, idle and/or low-power condition.

15. The aircraft comprising the propulsion system of claim 14, wherein:
the other modes of operation provide a range of power conditions.
